(19) United States
(12) Patent Application Publication
(10) Pub. No.: US 2017/0163058 A1
(43) Pub. Date: Jun. 8, 2017

(54) MOBILE ENERGY SOURCES FOR BUFFERING MAINS ENERGY AND FOR PROVIDING ENERGY

(71) Applicant: BVB Innovate GmbH, Stuttgart (DE)

(72) Inventor: Manfred Baumgärtner, Stuttgart (DE)

(21) Appl. No.: 15/440,176

(22) Filed: Feb. 23, 2017

Related U.S. Application Data
(63) Continuation of application No. PCT/EP2015/067866, filed on Aug. 4, 2015.

(30) Foreign Application Priority Data
Aug. 27, 2014 (DE) 10 2014 012 479.7

(51) Int. Cl. H02J 7/00; B60L 11/18; H02J 7/35

(52) U.S. Cl. CPC H02J 7/0027; H02J 7/35; B60L 11/1838; B60L 11/1811

(57) ABSTRACT

A mobile energy system (MES) can absorb, temporarily store and restore electric energy through connection to the house network. The energy can furthermore be released at the location of charging, at other locations or while driving. This offers the possibility of operating stationary or mobile quick charging stations also at locations which permit only small power output. By coupling the systems via a cloud, functions of a virtual power station can be performed.

### CROSS-REFERENCE TO RELATED APPLICATIONS

This continuation application claims priority to PCT/EP2015/067866 filed on Aug. 4, 2015 which has published as WO 2016/030151 A1 and also the German application number 10 2014 012 479.7 filed on Aug. 27, 2014, the entire contents of which are fully incorporated herein with these references.

### DESCRIPTION

Field of the Invention

The present invention generally relates to energy systems. More particularly, the present invention relates to a mobile, trailer-based energy system.

Background of the Invention

The provision of mobile electric energy while driving is disclosed in a series of patents such as e.g. in DE 10 2008 006 332 A1, DE 10 2012 011 960 A1 or as a systemic solution in DE 10 2012 015 099 A1. However, these systems are not suited to absorb energy that has been produced at the location itself and provide this energy again for applications at the location.

It is the object of the invention to provide more versatile use of a mobile, trailer-based energy system, in particular, wherein the load on a public electricity network can be relieved.

### SUMMARY OF THE INVENTION

This object is achieved by a mobile, trailer-based energy system and the use of a mobile, energy-based energy system according to the independent claims. Preferred embodiments and variants thereof are described in the dependent claims.

### BRIEF DESCRIPTION OF THE DRAWINGS

FIG. 1 illustrates a mobile energy system embodying the present invention;

FIG. 2 illustrates a control system for the embodiment of FIG. 1;

FIG. 3 illustrates an overall inventive system embodying the present invention;

FIG. 4 illustrates the connection of the MES to an electric vehicle with respect to current;

FIG. 5 illustrates the connection of the MES to an electric vehicle with respect to control and data;

FIG. 6 illustrates a nomad rolling battery for off-grid current supply;

FIG. 7 illustrates an inventive architecture of the present invention; and

FIG. 8 illustrates the MES which can be used as a mobile charging or quick charging for electric vehicles.

### DETAILED DESCRIPTION OF THE PREFERRED EMBODIMENTS

The invention described herein is based on a mobile energy system (MES) which can be moved and can be coupled via a drawbar to the standard trailer coupling of vehicles and in this way can be transported without any problem.

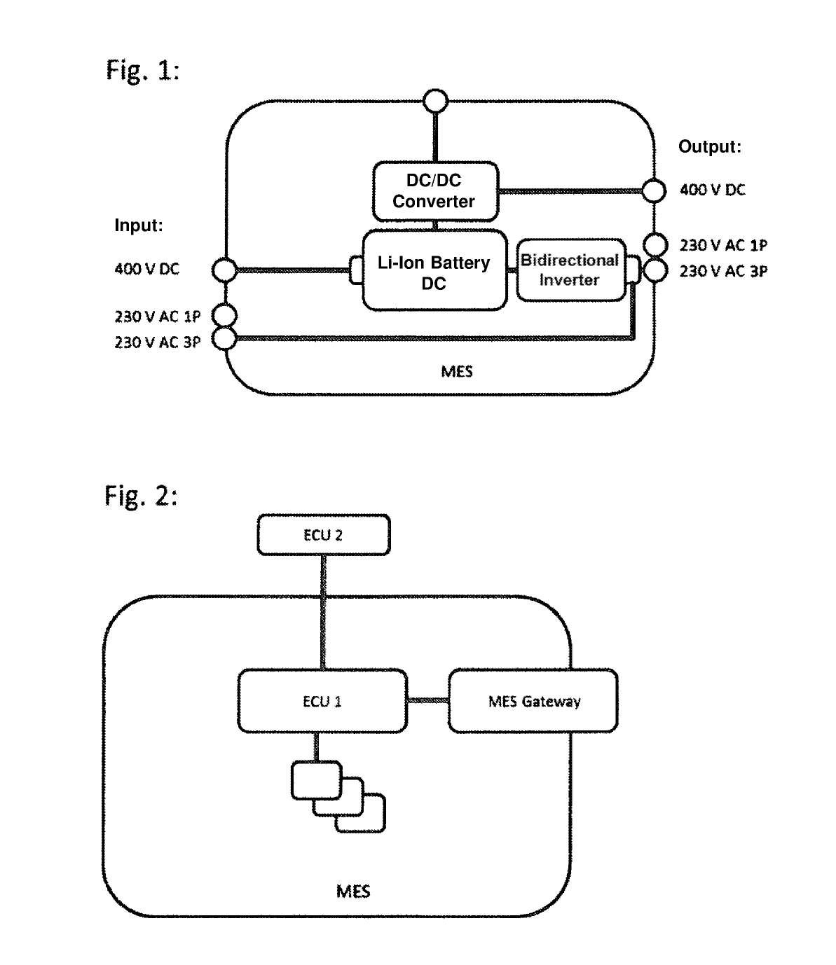

An inventive MES is shown, by way of example, in FIG. 1 (high current) and FIG. 2 (control). It consists of a battery, a DC-DC converter (DC=direct current), an AC-DC-converter (AC=alternating current), contactors or power-electronic switches for switching on and off the high current connections as well as plug connections for the high current input and output. It is controlled via a control device network with an ECU1 (=electronic control unit 1) as main control device. The data is provided via a gateway. The MES thus consists of the required power-electronic components in order to be able to connect them to the electricity network and also to electric vehicles (BEV=Battery Electric Vehicle) of any type of construction.

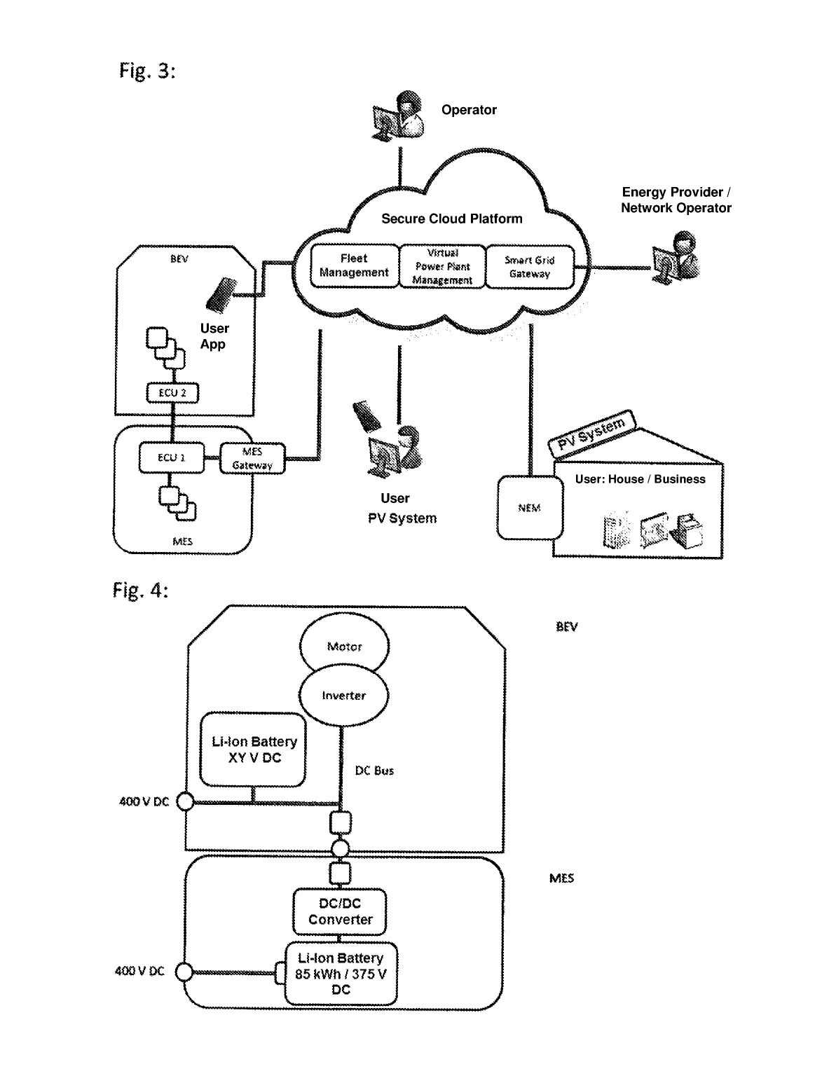

FIG. 3 shows the overall inventive system by way of example. It is called Nomad and consists of: the above-described mobile energy system (MES); the nomad energy manager (NEM); and the secure cloud platform (SCP).

The inventive system utilizes the trailer-based battery as a component of a virtual power station which can absorb and store energy from the network or from energy producers such as photovoltaic systems or block-type thermal power stations.

The battery can be electrically connected to the house network via a socket. Surprisingly, the data coupling is then realized not directly, but indirectly and in several stages, namely from NEM via SCP to MES and vice versa. This enables homogeneous and consolidated data acquisition and control of both components (MES and house network) both in case the MES is connected to the house installation and also in case the MES is on the road (as range extender at an electric vehicle or as energy source for off-grid applications). Integrated data generation of all parameters in real time on the cloud platform can be realized only in this manner.

The energy of the trailer batteries is released again when required, either at the location by using it in the house network of the producer or by feeding via the house network into the public network. Or the stored energy can be moved to any other locations in order to provide energy there for off-grid applications, e.g. for festivals or building sites. A further application in accordance with the invention is the recharging of electric vehicles either in case of vehicles that have broken down along the roadside due to an empty traction battery, at the charging location itself or at any other location where slow charging or quick charging of electric vehicles is required.

The system is furthermore suited to absorb off-grid generated energy in order to be released at the location itself or after transport at the location of requirement, e.g. for quick charging of electric vehicles, movable machines or special vehicles. Moreover, in this manner off-grid systems can also be connected to the network or other off-grid structures through road transport of the electric energy.

These applications allow e.g. to remove large amounts of excess energy at midday from PV production (PV=photovoltaic) from the network and use it for road traffic and other off-grid applications. This facilitates further expansion of renewable power generation and opens a completely new market for renewable power generation.

The MES are used both within the scope of rental systems and also in ownership by owners of houses and electric vehicles.

Connection of MES to the Secure Cloud Platform:

The central element of the communication infrastructure is the secure cloud platform (SCP). This is a safe infrastructure of virtualized servers which are connected to one another via a backbone encryption, e.g. SSL. The MES are connected to the SCP via mobile radio (e.g. G4, LTE), preferably via an own APN network (APN=Access Point Name).

In the same way, the nomad energy managers (NEM) are connected, which enable intelligent management of the energy production e.g. of a photo voltaic roof system (PV=photovoltaic) or of a block-type thermal power station and of the energy consumption (temporary storage in the MES, control of electric consumers) in a Smart Home.

It should be noted that in general, a plurality, e.g. more than 100 or preferably more than 1000, MES and NEM is connected to the SCP.

The secure cloud contains data management, thereby observing data protection aspects and also software functionalities that run centrally or in a decentralized manner for controlling the overall system, in particular Vehicle Tracking, Fleet Management, CRM (Customer Relationship Manager), service and maintenance, ticketing. Energy providers and network operators are centrally connected via a gateway (smart grid gateway) and can therefore call up the provision of energy from the virtual power plant.

Users can access their current data in real time via a web application or a smartphone app. This functionality enables provision of a user interface in the cockpit of the electric vehicle in a simple manner during a long-distance journey with docked MES. Towards this end, a smart phone, either the person's own smart phone or another one that has been provided, is simply pinned to the front windscreen. In order to be able to ensure full functionality even in case of missing radio connection, a direct back-up connection to the nomad rolling battery can be utilized. It is guided via cables into the vehicle and then preferably via WLAN to the smartphone.

Provision of energy while driving:

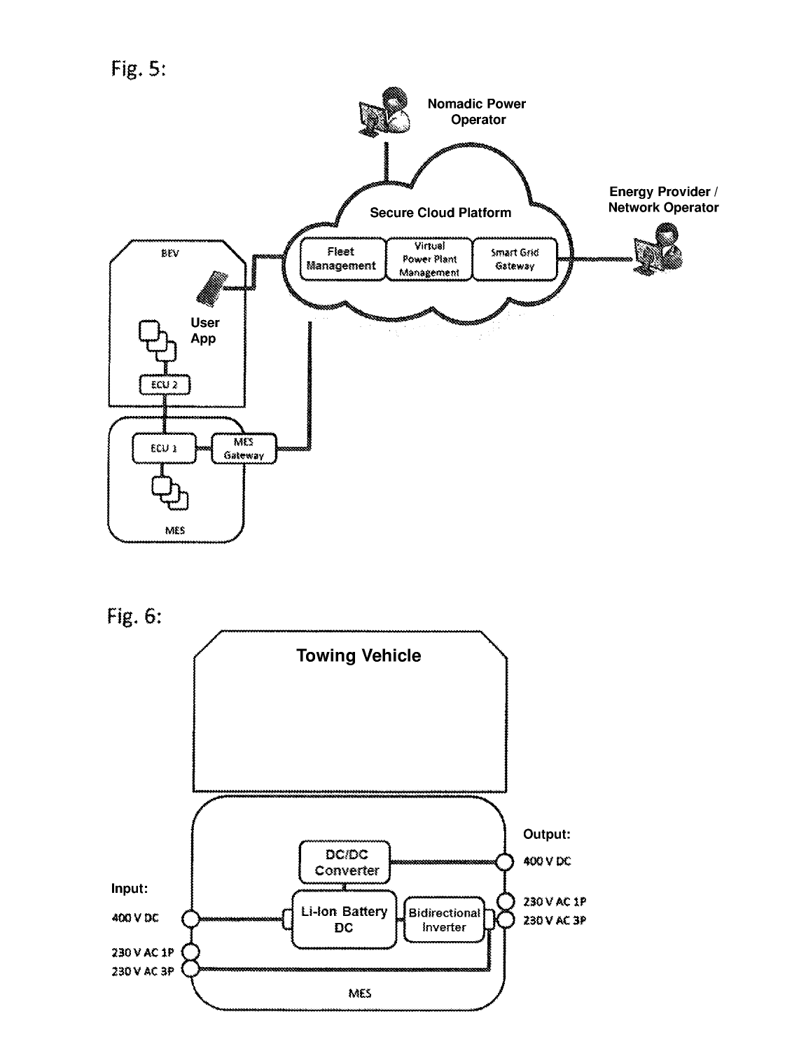

FIG. 4 (current) and FIG. 5 (control and data) show by way of example the connection of the MES to an electric vehicle. All components of the MES such as the intelligent BMS (battery management system) of the battery, the DC/DC converter, the bidirectional inverter and the contactors are connected as control device network on a private CAN bus (CAN=controller area network) to the main control device ECU1. The main control device is preferably connected via Ethernet to the gateway which is in turn connected as APN to the secure cloud platform.

All components authenticate themselves with respect to the ECU. The ECU authenticates itself with respect to the gateway preferably via an authentication software and key administration which is located on the chip of the SIM card (subscriber identity module, a secure element) of the gateway and cannot be compromised for this reason. A web server preferably runs on the gateway, with the web server providing the M2M data (M2M=machine to machine) in real time to the secure cloud platform.

Off-grid current supply:

FIG. 6 shows by way of example the nomad rolling battery for off-grid current supply. The quick charging device is illustrated on the left-hand side. The 85 kWh battery can be charged within a short time via the network by means of a fast charger or a supercharger. A further charging possibility is AC power, both 3-phase and also single-phase. The alternating current is thereby converted into direct current in a bidirectional inverter. Owing to the bidirectional mode of operation, these connections are also used as outlets for providing alternating current. 400 V DC can furthermore be provided for quick charging via a DC/DC converter. The generation of rotary current via this connection is also possible via an inverter on the consumer side. The described architecture enables quick charging of the system both by means of alternating current and also by means of direct current. In a preferred variant, it provides up to 85 kWh as alternating or direct current and enables DC quick charging. This is of particular importance in case of recharging broken down electric vehicles within the scope of roadside assistance or in the use as quick charging station.

Range Extender Operation:

In a similar manner, the system can also be used to supply electric vehicles with energy or to recharge their battery while driving. In this manner, up to 500 km of additional range may be obtained and in case of exchange of the MES even unlimited ranges can be achieved.

FIG. 4 shows by way of example the design of this system variant. The on-board inverter can be omitted when the system is to be operated in cooperation with AC quick charging stations. The DC/DC converter guides the current via contactors and a cable to the electric vehicle.

The electric vehicle was retrofitted by an installation kit in such a manner that the power cable of the MES can be furnished via a secure plug connection. The energy of the MES is fed to the DC high current bus of the electric vehicle via a further set of contactors. The ECU2 contained in the installation kit reads out the operating data and the VIN number of the electric vehicle on the public bus.

The system can then be adjusted to the respective electric vehicle via the voltage level which can be freely selected by the DC/DC converter. In the operating mode, the voltage level of the current supplied by the nomad rolling battery is adjusted in such a manner that it is somewhat higher than that of the traction battery of the electric vehicle. In this way, the energy called up by the inverter is mainly provided by the nomad rolling battery. Further, the traction battery is recharged in the course of time such that at the end of the journey with the nomad rolling battery, the charging state of the vehicle battery will be higher. The recuperation energy is fed back into the vehicle battery.

Installation kit:

In order to be able to connect the MES to an electric vehicle, the electric vehicle is provided with an installation kit which consists of the following components:

Trailer coupling: Since many electric vehicles are not (yet) equipped for operation with a trailer coupling, a suspension is individually constructed for each model to be integrated, is tested in a continuous stress test and authorized for the particular construction. The trailer coupling is preferably designed as a removable model.

Combination socket: for high current (preferably 250A, 400V DC), on-board electric system and data (CAN bus). The socket is connected to the plug of the nomad rolling battery and is then electrically locked. The current can only be switched on after locking. The system is protected from dust, corrosion and splashing water.

Power switches such as contactors or power-electronic switches (MOSFETs) and two-core high current cable, preferably with a diameter of 50mm² per core, for connection to the DC high current bus of the electric vehicle.

ECU2 for controlling the functionalities of the installation kit, for connection to the public bus of the electric vehicle for interpreting vehicle data and the VIN number (vehicle identification number), web server and WLAN.

Stationary mode and coupling with the network

This variant again includes the bidirectional inverter. The MES can be connected to the house network by synchronization of the phase position with the AC bus of the house installation. The AC connection thereby serves both for charging the MES and also for feeding back into the house network.

FIG. 7 shows by way of example the inventive architecture of the system. The system is suited, in particular, for management of the energy produced by a PV system (rooftop system) or a block-type thermal power station (BHKW). The PV system is connected to the AC bus of the house installation as usual via an inverter. The individual consumers are branched off from this inverter. The house installation is connected to the public network (smart grid) via the meter (Smart Meter).

The central intelligence for controlling the overall system is the Nomad Energy Manager (NEM). The NEM has an intelligent control which processes the data of the Smart Meter, of the inverter of the PV system and of external sources (weather forecast, virtual power plant operators). It is connected to the MES via the secure cloud platform or in case of an error in the connection it is directly connected to the gateway thereof.

Consequently, the NEM can exactly signal to the MES which behavior it is to assume: storage of the generated PV current (e.g. in supply peaks during the day); feeding back for supplying the consumer of the house (in particular in the mornings, evenings and at night); and feeding back into the public network within the scope of the virtual power station.

The NEM is furthermore provided with the possibility of remote control for different consumers. In this manner, the consumers can be connected to or disconnected from the network as required. All settings can be performed remotely via the smartphone app. Moreover, the system can optimize itself in the course of time in a self-learning manner.

In contrast to conventional and commercially available buffer systems, the battery is in the position to not only shift the daily requirements but also to manage the overall weekly requirements of a household. In order to guarantee this, all supply peaks on sunny days can be stored such that there will be no undesired feeding. The stored energy is moreover available to be consumed in the electric vehicle. From the viewpoint of the energy provider, this generates a highly attractive distributed system for removing excessive supply peaks and the consumption thereof on the road.

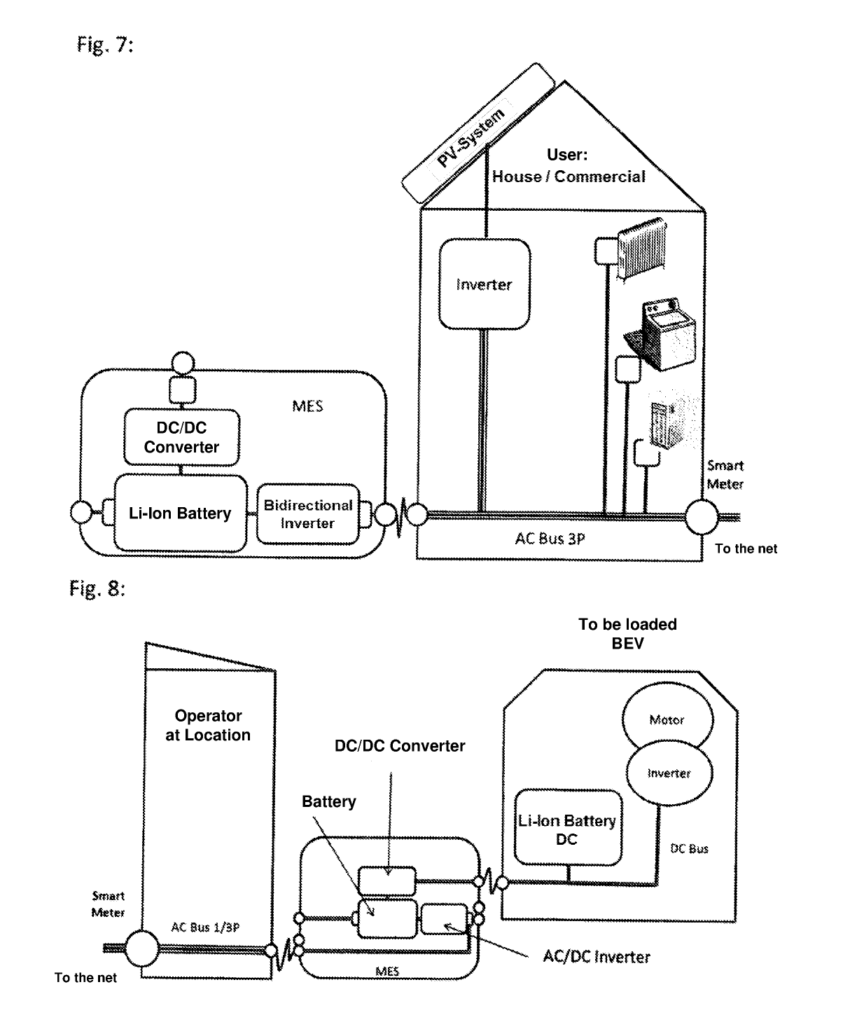

As a surprise for the expert, the MES can also be used as a mobile charging or quick charging station for electric vehicles (see by way of example FIG. 8). Charging is realized here via single-phase or 3-phase alternating current or via direct current, preferably 400 V DC). The MES in turn offers the energy in the form of a single-phase or 3-phase alternating current or as direct current, corresponding to a mode 1, mode 2, CCS (Combined Charging System) or CHAdeMO charging system.

A particular advantage of this design is that charging of the MES can be performed in a slow and network-friendly manner while the charging of the electric vehicle can be performed according to a quick charging mode. This enables quick charging at locations where high power fuses are not possible, and therefore no high charging power is available. The system furthermore offers the possibility to move the MES to the location where it is required, e.g. to an electric vehicle that has broken down due to an empty traction battery or to electric vehicles that have been parked somewhere else.

Embodiments of the invention:

The present invention relates, in particular, in a first embodiment to a mobile trailer-based energy system consisting of a battery and an AC/DC converter, characterized in that it can be electrically connected to the network and is controlled via an energy manager (NEM) on the side of the house installation with respect to its functions of storing energy, feeding back for consumers in the house network or feeding back into the public network.

In a second embodiment, in the energy system of the first embodiment, the battery is connected to a DC/DC converter which permits provision of direct current of any voltage.

In an energy system of the second embodiment, it may further be provided that the system is used for charging or quick charging of vehicles at the location of the network.

In an energy system of the second embodiment, it may further be provided that the system is used for charging or quick charging of vehicles at the location of the vehicle or at any other location.

In an energy system of the first embodiment, it may furthermore be provided that it is connected via radio to a cloud platform which permits monitoring, control and integration in a virtual power station.

In an energy system of the second embodiment, it may furthermore be provided that it is connected via radio to a cloud platform which permits monitoring, control and integration in a virtual power station.

In an energy system of the second embodiment, it may further be provided that it absorbs off-grid generated energy and provides this energy to be consumed or fed during travelling or at another location.

In an energy system of the second embodiment, it may further be provided that it absorbs energy from the network and provides this energy to be consumed or fed during travelling or at another location.

In an energy system of the first embodiment, it may further be provided that it absorbs off-grid generated energy and provides this energy to be consumed or fed during travelling or at another location.

In an energy system of the first embodiment, it may further be provided that it absorbs energy from the network and provides this energy to be consumed or fed during travelling or at another location.

In summary, a mobile energy system (MES) is described which can absorb, temporarily store and restore electric energy through connection to the house network. The energy may moreover be released at the location of charging, at other locations or while driving. This offers the possibility to operate stationary or mobile quick charging stations also at locations that permit only small power outputs. Coupling of the systems via a cloud permits performance of the functions of a virtual power station.

What is claimed is:

1. The use of a mobile trailer-based energy system (MES) comprising:
a battery; and
an AC/DC converter;
wherein the energy system (MES) is at least at times electrically connected via the house network of a house installation to a public electricity network;
wherein the mobile energy system (MES) is controlled via an energy manager (NEM) on the side of the house installation with respect to its functions of storing energy from the house network, feeding back of energy into the house network for consumers in the house network or feeding back of energy into the public electricity network;
wherein the energy system (MES) is connected on the data side via radio to a cloud platform (SCP) to which, in addition to the energy system (MES), a plurality of further mobile, trailer-based energy systems (MES) and energy managers (NEM) are connected such that the energy system (MES) forms together with the further energy systems (MES) a virtual power station;
wherein the cloud platform (SCP) performs monitoring and control of the energy systems (MES),
wherein the energy system (MES) on the data side is not directly connected to the energy manager (NEM) but via the cloud platform (SCP); and
wherein an energy provider and a network operator of the public electricity network are centrally connected to the cloud platform (SCP) on the data side such that the energy provider and the network operator can call up the provision of energy from the energy systems (MES) of the virtual power station into the public electricity network.

2. The use according to claim 1, wherein the energy system (MES) comprises a DC/DC converter to which the battery is connected, wherein the DC/DC converter enables provision of direct current of any voltage, and wherein the energy system (MES) is used at least at times for charging or quick charging of vehicles at the location of the network.

3. The use according to claim 1, wherein the energy system (MES) comprises a DC/DC converter to which the battery is connected, wherein the DC/DC converter permits provision of direct current of any voltage, and wherein the energy system (MES) is moved at least at times from the location of the network to any other locations and is used for charging or quick charging of vehicles at these optional other locations, wherein the vehicles have broken down along the side of the road due to an empty traction battery.

4. The use according to claim 1, wherein the energy system (MES) comprises a DC/DC converter to which the battery is connected, wherein the DC/DC converter permits provision of direct current of any voltage.

5. The use according to claim 1, wherein data acquisition and control of the energy system (MES) and the energy manager (NEM) are performed via the cloud platform (SCP), both when the energy system (MES) is connected to the house installation and also when the energy system (MES) is on the road, wherein the energy system is a range extender for an electric vehicle or is an energy source for off-grid applications.

6. The use according to claim 1, wherein the energy system (MES) absorbs at least at times off-grid generated energy and provides this energy to be consumed or fed during travelling or at another location, wherein it is provided that the energy system (MES) comprises a DC/DC converter to which the battery is connected, wherein the DC/DC converter permits provision of direct current of any voltage.

7. The use according to claim 1, wherein the energy system (MES) absorbs at least at times energy from the public electricity network and provides this energy to be consumed or fed during travelling or at another location, wherein it is provided that the energy system (MES) comprises a DC/DC converter to which the battery is connected, wherein the DC/DC converter permits provision of direct current of any voltage.

8. The use according to claim 1, wherein the house installation comprises an energy producer being a photovoltaic system (PV) or a block-type thermal power station (BHKW).

9. The use according to claim 8, wherein the energy manager (NEM) performs intelligent management of the energy production by the energy producer and of the energy consumption by consumers in the house network, including the temporary storage of energy of the energy producer in the energy system (MES) and of the control of the electric consumers in the house network.

10. The use according to claim 1, wherein the energy manager (NEM) comprises a remote control function for different consumers in the house network, and the consumers are connected to or disconnected from the public electricity network as required.

11. The use according to claim 1, wherein all components of the energy system (MES) including a battery management system (BMS) of the battery, a DC/DC converter and a bidirectional inverter and contactors, are connected as a control device network on a private CAN bus to a main control device (ECU1), and wherein the main control device (ECU1) is connected to a gateway of the energy system (MES) via Ethernet.

12. The use according to claim 1, wherein the AC/DC converter is a bidirectional inverter.

13. The use according to claim 1, wherein the battery can be connected to the house network via a socket.
